(19) United States
(12) Patent Application Publication
(10) Pub. No.: US 2026/0279703 A1
(43) Pub. Date: Sep. 17, 2026

(54) LIMIT SWITCH

(71) Applicant: OMRON CORPORATION, Kyoto-shi, Kyoto (JP)

(72) Inventors: Yusuke KOMOGUCHI, Kyoto-shi, Kyoto (JP); Kazuyuki TSUKIMORI, Kyoto-shi, Kyoto (JP); Kouhei YOSHIDA, Kyoto-shi, Kyoto (JP); Sho OGAWA, Kyoto-shi, Kyoto (JP)

(21) Appl. No.: 19/162,846

(22) PCT Filed: Feb. 19, 2024
(86) PCT No.: PCT/JP2024/005725

§ 371 Date: Sep. 5, 2025

(30) Foreign Application Priority Data
Mar. 10, 2023 (JP) 2023-038034

(51) Int. Cl. H01H 21/28; H01H 3/62; H01H 21/42

(52) U.S. Cl. CPC H01H 21/28; H01H 3/62; H01H 21/42; H01H 2239/072

(57) ABSTRACT

A limit switch includes: a switch main body; and an operation unit connected to the switch main body. The operation unit includes: a housing; a shaft member; and an urging portion. The urging portion includes: an elastic member; a return plunger; and a guide member having higher heat resistance than the housing. The elastic member is stretchable along a center line extending in the second direction and configured to bias the shaft member. The return plunger is positioned between the elastic member and the shaft member in the second direction, movable along the center line, and configured to transmit a biasing force of the elastic member to the shaft member. The guide member is attached to the housing and configured to accommodate the return plunger inside the guide member and to guide movement of the return plunger.

### TECHNICAL FIELD

The present disclosure relates to a limit switch.

### BACKGROUND ART

Patent Document 1 discloses a limit switch including a housing in which a built-in switch is accommodated. The limit switch includes a rotatable shaft having a cam portion, and a switch operation plunger that moves in accordance with rotation of the shaft. When the cam portion is inclined in accordance with rotation of the shaft, the switch operation plunger moves in a direction away from the shaft, and the built-in switch is turned on and off.

### PRIOR ART DOCUMENT

### Patent Document

Patent Document 1: JP 2015-204223 A

### SUMMARY OF THE INVENTION

### Problems to be Solved by the Invention

For example, in a coating line, a limit switch may be used in a high temperature environment of about 160 degrees Celsius. In general, a heat-resistant temperature of the limit switch is about 120 degrees Celsius at the maximum, and therefore when the limit switch is used in a high temperature environment, the limit switch may fail in a short period of time.

An object of the present disclosure is to provide a limit switch capable of improving heat resistance.

### Solutions to the Problems

A limit switch according to one aspect of the present disclosure includes:
a switch main body; and
an operation unit connected to the switch main body, in which
the operation unit includes:
   a housing;
   a shaft member extending from an outside of the housing to an inside of the housing along a first direction and supported by the housing in a state rotatable from a return position to an operation position around a rotation axis extending in the first direction; and
   an urging portion positioned inside the housing and biasing the shaft member in a second direction intersecting the first direction and in a direction approaching the switch main body to return the shaft member to the return position, and
the urging portion includes:
   an elastic member stretchable along a center line extending in the second direction and configured to bias the shaft member;
   a return plunger positioned between the elastic member and the shaft member in the second direction, movable along the center line, and configured to transmit a biasing force of the elastic member to the shaft member; and
   a guide member attached to the housing, configured to accommodate the return plunger inside the guide member and to guide movement of the return plunger, and having higher heat resistance than the housing.

### EFFECTS OF THE INVENTION

According to the present disclosure, it is possible to realize a limit switch capable of improving heat resistance.

### BRIEF DESCRIPTION OF THE DRAWINGS

FIG. 1 is a perspective view illustrating a limit switch of an embodiment of the present disclosure.

FIG. 2 is a cross-sectional view taken along line II-II of FIG. 1.

FIG. 3 is a cross-sectional view taken along line III-III of FIG. 1.

FIG. 4 is a cross-sectional view illustrating an example of an operation unit of a limit switch not including a guide member.

### DETAILED DESCRIPTION

Hereinafter, an example of the present disclosure will be described with reference to the accompanying drawings. The following description is merely exemplary in nature and is not intended to limit the present disclosure, the application object of the present disclosure, and the application of the present disclosure. The accompanying drawings are schematic, and ratios of dimensions and the like do not necessarily match actual ones.

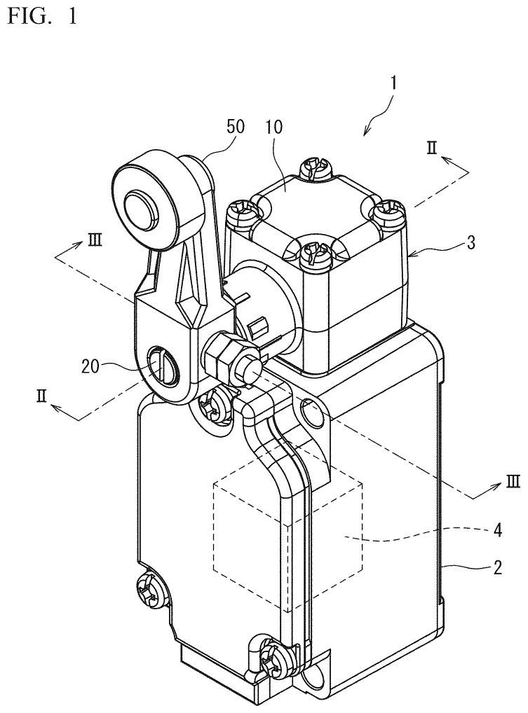

As shown in FIG. 1, a limit switch 1 according to an embodiment of the present disclosure includes a switch main body 2 configured to be switched on and off, and an operation unit 3 connected to the switch main body 2.

As an example, the switch main body 2 has a substantially rectangular parallelepiped shape as shown in FIG. 1. An operation unit 3 is detachably connected to one surface of the switch main body 2. The switch main body 2 incorporates a switch portion 4 configured to be switched on and off by rotation of a shaft member 20 described later. In the present embodiment, the switch portion 4 is made of a material containing a polyether ether ketone resin (PEEK resin).

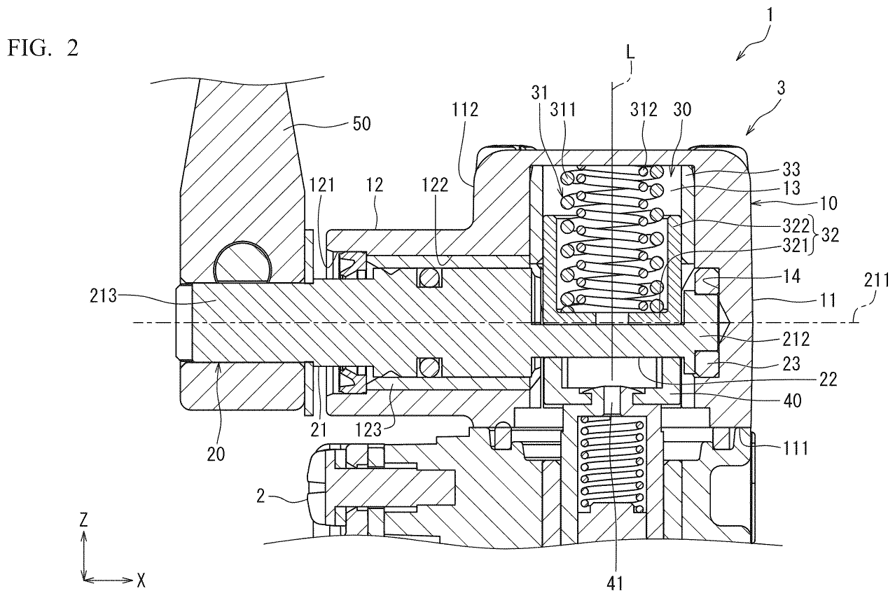

As shown in FIG. 2, the operation unit 3 includes a housing 10, a shaft member 20, and an urging portion 30. In the present embodiment, the operation unit 3 includes an operation plunger 40 and an operation lever 50. The shaft member 20 extends from an outside of the housing 10 to an inside of the housing 10 along a first direction (for example, in the X direction). The urging portion 30 and the operation plunger 40 are positioned inside the housing 10. The operation lever 50 is positioned outside the housing 10.

As an example, the housing 10 is made of a material containing aluminum, and includes a housing main body 11 having a hollow substantially cubic shape and a peripheral wall portion 12 having a substantially cylindrical shape. The peripheral wall portion 12 is provided on one side surface 112 adjacent to a surface 111 of the housing main body 11 facing the switch main body 2.

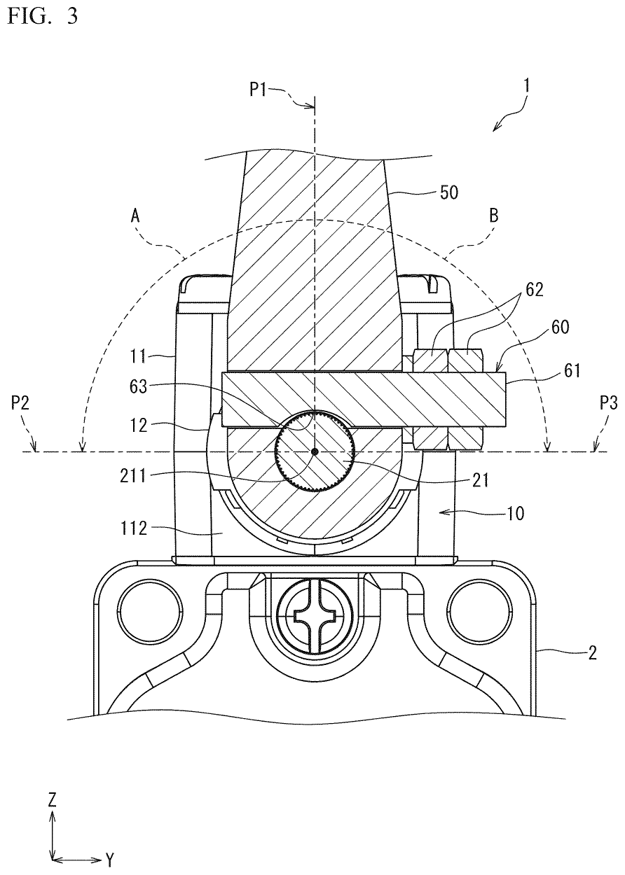

The housing main body 11 is connected to the switch main body 2, and includes an accommodating portion 13 and a recessed portion 14 inside the housing main body 11 as shown in FIG. 3. The urging portion 30 and the operation plunger 40 are accommodated in the accommodating portion 13 in a state of being movable in a direction (for example, in the Z direction) intersecting the first direction X. The recessed portion 14 is provided on an inner wall constituting the accommodating portion 13, and is recessed from the inner wall of the accommodating portion 13 in the first direction X and in a direction away from the peripheral wall portion 12. The recessed portion 14 accommodates an end portion 212 of the shaft member 20 positioned inside the housing 10 and a support member 23 positioned at the end portion 212 of the shaft member 20. The support member 23 has higher heat resistance than the housing 10 and is configured to rotatably support the end portion 212 of the shaft member 20. In the present embodiment, the support member 23 is made of a material containing stainless steel and has a substantially annular shape.

The peripheral wall portion 12 extends from the side surface 112 of the housing main body 11 along a second direction Z. The peripheral wall portion 12 includes an opening 121 provided on a surface far from the housing main body 11 in the first direction X, and a through hole 122 extending inside the peripheral wall portion 12 along the first direction X and connected to the accommodating portion 13 and the opening 121. The through hole 122 is provided with a bearing portion 123 that rotatably supports the shaft member 20.

As an example, the shaft member 20 includes a shaft main body 21 and a cam portion 22.

The shaft main body 21 has, for example, a substantially columnar shape extending along the first direction X, and extends from the outside of the housing 10 to the inside of the housing 10 along the first direction X. The shaft main body 21 is configured to be rotatable forward and backward about a rotation axis 211 extending along the first direction X. As an example, in FIG. 3, a direction of an arrow A is a forward direction, and a direction of an arrow B is a reverse direction. The position of the shaft member 20 rotated from a return position P1 by approximately 90 degrees in the direction of the arrow A is defined as a first operation position P2, and the position of the shaft member 20 rotated from the return position P1 by approximately 90 degrees in the direction of the arrow B is defined as a second operation position P3. In this case, the shaft main body 21 is supported by the housing 10 in a state of being rotatable around the rotation axis 211 from the return position P1 to the first operation position P2 and the second operation position P3.

The cam portion 22 is provided in a portion of the shaft main body 21 positioned inside the housing 10, and is configured to be rotatable around the rotation axis 211 together with the shaft main body 21. A return plunger 32 of the urging portion 30 to be described later is in contact with the cam portion 22. When the shaft main body 21 is positioned at the return position P1, most of the cam portion 22 is positioned closer to the switch main body 2 than the rotation axis 211 in the second direction Z. When the cam portion 22 rotates, the return plunger 32 and the operation plunger 40 are moved to be separated from each other along the second direction Z.

In the present embodiment, the shaft member 20 is coated with fluorine grease.

The urging portion 30 is configured to urge the shaft member 20 in the second direction Z and in the direction approaching the switch main body 2 to return to the return position Pl. In the present embodiment, the urging portion 30 is positioned farther from the switch main body 2 than the cam portion 22 in the second direction Z.

The urging portion 30 includes an elastic member 31, a return plunger 32, and a guide member 33.

The elastic member 31 is stretchable along a center line L extending in the second direction Z and is configured to bias the shaft member 20 via the return plunger 32. In the present embodiment, the elastic member 31 includes two coil springs 311 and 312 having different diameters (for example, a central diameter, an inner diameter or an outer diameter). Each of the coil springs 311 and 312 is configured by, for example, an oil temper wire. The coil spring 312 having a small diameter is positioned in an internal space of the coil spring 311 having a large diameter.

The return plunger 32 is positioned between the elastic member 31 and the shaft member 20 in the second direction Z, is movable along the center line L, and is configured to transmit a biasing force of the elastic member 31 to the shaft member 20. In the present embodiment, the return plunger 32 has a substantially cylindrical shape and includes a plate portion 321 and a cylindrical portion 322. The plate portion 321 has a substantially circular plate shape, and is configured to contact the cam portion 22 and the elastic member 31 to transmit the biasing force of the elastic member 31 to the cam portion 22. The cylindrical portion 322 is configured to extend along the second direction Z from an edge portion of a surface of the plate portion 321 facing the elastic member 31 to guide movement of the plate portion 321 in the second direction Z.

The guide member 33 is made of, for example, a material containing stainless steel, and has higher heat resistance than the housing 10. The guide member 33 is attached to the housing 10 and is configured to accommodate the return plunger 32 inside the guide member 33 to guide the movement of the return plunger 32. In the present embodiment, the guide member 33 has a substantially cylindrical shape capable of accommodating the return plunger 32 therein, and is fixed to an inner surface constituting the accommodating portion 13 of the housing 10.

The operation plunger 40 is positioned between the switch main body 2 and the cam portion 22 in the second direction Z, and faces the cam portion 22 in the second direction Z. One end of a transmission member 41 movable together with the operation plunger 40 is connected to the operation plunger 40. The other end of the transmission member 41 is connected to the switch portion 4. The operation plunger 40 is configured to move in the second direction Z by a rotation of the cam portion 22 to switch on and off of the switch portion 4 via the transmission member 41.

The operation lever 50 is positioned at an end portion 213 of the shaft member 20 positioned outside the housing 10. In the present embodiment, the operation lever 50 extends in a direction intersecting (for example, orthogonal) the shaft member 20 and is configured to be rotatable together with the shaft main body 21. The operation lever 50 is fixed to the shaft member 20 by a fastening member 60.

As shown in FIG. 3, the fastening member 60 includes a shaft 61 and at least one nut (in the present embodiment, two nuts 62). The shaft 61 extends from an outside to an inside of the operation lever 50 along the first direction X and the second direction Z. A recessed portion 63 for accommodating a part of the shaft member 20 is provided in a portion of the shaft 61 positioned inside the operation lever 50. The recessed portion 63 has a curved shape along the outer shape of the shaft main body 21 and is configured to accommodate a part of the shaft main body 21. The two nuts 62 are attached to a portion of the shaft 61 positioned outside the operation lever 50. By tightening the two nuts 62, a part of the shaft main body 21 accommodated in the recessed portion 63 is mechanically tightened.

The limit switch 1 can exhibit the following effects.

The limit switch 1 includes the switch main body 2 and the operation unit 3 connected to the switch main body 2. The operation unit 3 includes the housing 10, the shaft member 20, and the urging portion 30. The shaft member 20 extends from the outside of the housing 10 to the inside of the housing 10 along the first direction X, and is supported by the housing 10 in a state of being rotatable from the return position P1 to the first operation position P2 or the second operation position P3 around the rotation axis 211 extending in the first direction X. The urging portion 30 is positioned inside the housing 10, and biases the shaft member 20 in the second direction Z and in the direction approaching the switch main body 2 to return the shaft member 20 to the return position P1. The urging portion 30 includes the elastic member 31, the return plunger 32, and the guide member 33 having higher heat resistance than the housing 10. The elastic member 31 is stretchable along the center line L extending in the second direction Z and is configured to bias the shaft member 20. The return plunger 32 is positioned between the elastic member 31 and the shaft member 20 in the second direction Z, is movable along the center line L, and is configured to transmit the biasing force of the elastic member 31 to the shaft member 20. The guide member 33 is attached to the housing 10 and is configured to accommodate the return plunger 32 inside the guide member 33 and to guide the movement of the return plunger 32. With such a configuration, for example, even in a high temperature environment of 160 degrees Celsius, it is possible to suppress occurrence of malfunction of the return plunger 32 caused by scraping of the inside of the housing 10 due to sliding of the return plunger 32.

The operation unit 3 includes the support member 23 having higher heat resistance than the housing 10. The support member 23 is positioned at the end portion 212 of the shaft member 20 positioned inside the housing 10 and is configured to rotatably support the end portion 212 of the shaft member 20. With such a configuration, for example, even in a high temperature environment of 160 degrees Celsius, sliding resistance between the shaft member 20 and the housing 10 can be reduced, and the occurrence of malfunction of the shaft member 20 can be suppressed.

The operation unit 3 includes the operation lever 50 positioned at the end portion 213 of the shaft member 20 positioned outside the housing 10, and the fastening member 60 that fixes the operation lever 50 to the shaft member 20. The fastening member 60 includes the shaft 61 extending along the third direction Y and provided with the recessed portion 63 that houses a part of the shaft member 20, and the nut 62 positioned at one end of the shaft 61. With such a configuration, since the operation lever 50 is mechanically fixed to the shaft member 20, for example, the occurrence of idling of the operation lever 50 can be suppressed even in a high temperature environment of 160° C.

The elastic member 31 includes the two coil springs 311 and 312 having different diameters. With such a configuration, spring characteristics of the elastic member 31 can be improved. As a result, for example, a coil spring that is made of a material that has high heat resistance but cannot obtain desired spring characteristics alone, can be used as the elastic member 31.

The switch main body 2 includes the switch portion 4 configured to be switched on and of by rotation of the shaft member 20, and the switch portion 4 is made of a material containing polyether ether ketone resin. With such a configuration, heat resistance of the switch portion 4 can be improved.

The operation unit 3 includes fluorine grease applied to the shaft member 20. With such a configuration, for example, even in a high temperature environment of 160 degrees Celsius, it is possible to reduce friction associated with rotation of the shaft member 20 while suppressing occurrence of recovery failure due to solidification of grease.

The limit switch 1 may be configured as follows.

The support member 23 may be omitted.

The operation lever 50 is not limited to the case of being fixed to the shaft member 20 by the fastening member 60, and any configuration capable of fixing the operation lever 50 to the shaft member 20 may be adopted.

The elastic member 31 is not limited to the case of including the two coil springs 311 and 312, and any configuration capable of urging the shaft member 20 to return the shaft member 20 to the return position PI may be adopted. For example, the elastic member 31 may include one coil spring or three or more coil springs, or may include other elastic members other than the coil springs.

The switch portion 4 is not limited to the case of being made of a material containing PEEK resin, and may be made of another material.

The operation unit 3 may or may not contain a lubricant applied to the shaft member 20. When the lubricant is contained, the lubricant may be fluorine grease or grease other than fluorine grease.

The switch main body 2 may adopt any configuration configured to be switched on and off via the operation plunger 40 by rotation of the shaft main body 21.

The operation unit 3 may be undetachably connected to the switch main body 2.

The peripheral wall portion 12 is not limited to being provided integrally with the housing main body 11, and may be provided separately. In this case, the peripheral wall portion 12 may be made of the same material as the housing main body 11 or may be made of a different material.

The shape and configuration of each member constituting the limit switch 1 in the above embodiment are merely examples, and any other shape and configuration may be adopted.

For example, the guide member 33 is not limited to the substantially cylindrical shape, and any shape that can cover at least a portion where the return plunger 32 and the housing 10 are in contact when the shaft member 20 rotates, may be adopted.

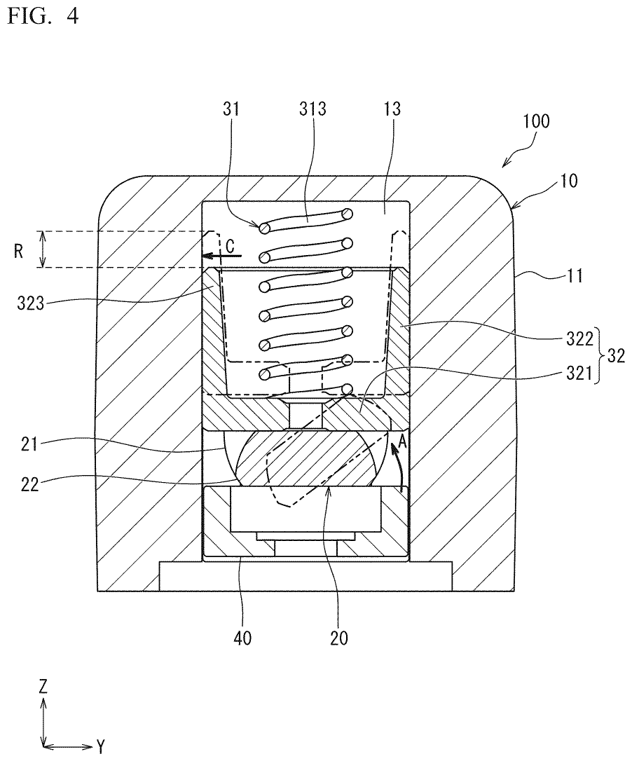

FIG. 4 illustrates an example of the operation unit 3 of a limit switch 100 not including the guide member 33. For example, when the shaft member 20 rotates in the direction of arrow A, the cylindrical portion 322 includes an end portion 323 that is an end of the cylindrical portion 322 of the return plunger 32 away from the shaft member 20 in the second direction Z and is positioned downstream in the direction of arrow A, the end portion 323 moves in the second direction Z and away from the shaft member 20 while being pressed against an inner surface of the housing 10 along the direction of arrow C. In the limit switch 100 of FIG. 4, a movement range R of the end portion 323 of the cylindrical portion 322 is included in the “portion where the return plunger 32 and the housing 10 are in contact when the shaft member 20 rotates”. The elastic member 31 includes one coil spring 313.

Various embodiments of the present disclosure have been described above in detail with reference to the drawings. Finally, various aspects of the present disclosure will be described. In the following description, as an example, reference numerals are also added.

A limit switch 1 according to a first aspect of the present disclosure includes:
a switch main body 2; and
an operation unit 3 connected to the switch main body 2, wherein
the operation unit 3 includes:
   a housing 10;
   a shaft member 20 extending from an outside of the housing 10 to an inside of the housing 10 along a first direction and supported by the housing 10 in a state rotatable from a return position to an operation position around a rotation axis 211 extending in the first direction; and
   an urging portion 30 positioned inside the housing 10 and biasing the shaft member 20 in a second direction intersecting the first direction and in a direction approaching the switch main body 2 to return the shaft member 20 to the return position, and
the urging portion 30 includes:
   an elastic member 31 stretchable along a center line extending in the second direction and configured to bias the shaft member 20;
   a return plunger 32 positioned between the elastic member 31 and the shaft member 20 in the second direction, movable along the center line, and configured to transmit a biasing force of the elastic member 31 to the shaft member 20; and
   a guide member 33 attached to the housing 10, configured to accommodate the return plunger 32 inside the guide member 33 and to guide movement of the return plunger 32, and having higher heat resistance than the housing 10.

In a limit switch 1 according to a second aspect of the present disclosure, in the limit switch 1 according to the first aspect,
the operation unit 3 is configured to rotatably support an end portion 212 of the shaft member 20 positioned inside the housing 10, and includes a support member 23 having higher heat resistance than the housing 10.

In a limit switch 1 according to a third aspect of the present disclosure, in the limit switch 1 according to the first aspect or the second aspect,
the operation unit 3 includes:
   an operation lever 50 positioned at an end portion 213 of the shaft member 20 positioned outside the housing 10; and
   a fastening member 60 that fixes the operation lever 50 to the shaft member 20, and
the fastening member 60 includes:
   a shaft 61 extending along a third direction intersecting the first direction and the second direction and provided with a recessed portion 63 that houses a part of the shaft member 20; and
   a nut 62 positioned at one end of the shaft 61.

In a limit switch 1 according to a fourth aspect of the present disclosure, in the limit switch 1 according to any one of the first to third aspects,
the elastic member 31 includes two coil springs 311 and 312 having different diameters.

In a limit switch 1 according to a fifth aspect of the present disclosure, in the limit switch 1 according to any one of the first to fourth aspects,
the switch main body 2 includes a switch portion 4 configured to be switched on and off by rotation of the shaft member 20, and
the switch portion 4 is made of a material containing polyether ether ketone resin.

In a limit switch 1 according to a sixth aspect of the present disclosure, in the limit switch 1 according to any one of the first to fifth aspects,
the operation unit 3 includes fluorine grease applied to the shaft member 20.

By appropriately combining any embodiments or modifications among the various embodiments or modifications, the effects of the respective embodiments or modifications can be achieved. In addition, combinations of embodiments, combinations of examples, or combinations of embodiments and examples are possible, and combinations of features in different embodiments or examples are also possible.

Although the present disclosure has been fully described in connection with preferred embodiments with reference to the accompanying drawings, various modifications and corrections will be apparent to those skilled in the art. Such modifications and corrections are to be understood as being included within the scope of the present disclosure as set forth in the appended claims.

### Industrial Applicability

The present disclosure is applicable to, for example, an assembly line of an automobile or the like.

### REFERENCE SIGNS LIST

1 limit switch
2 switch main body
3 operation unit
4 switch portion
10 housing
11 housing main body
111 surface
112 side surface
12 peripheral wall portion
121 opening
122 through hole
123 bearing portion
13 accommodating portion
14 recessed portion
20 shaft member
21 shaft main body
211 rotation axis
212, 213 end portion
22 cam portion
23 support member
30 urging portion
31 elastic member
32 return plunger
321 plate portion
322 cylindrical portion
323 end portion
33 guide member
40 operation plunger
41 transmission member
50 operation lever
60 fastening member
61 shaft
62 nut
63 recessed portion
100 limit switch

1. A limit switch, comprising:
a switch main body; and
an operation unit connected to the switch main body, wherein
the operation unit includes:
a housing;
a shaft member extending from an outside of the housing to an inside of the housing along a first direction and supported by the housing in a state rotatable from a return position to an operation position around a rotation axis extending in the first direction; and
an urging portion positioned inside the housing and biasing the shaft member in a second direction intersecting the first direction and in a direction approaching the switch main body to return the shaft member to the return position, and
the urging portion includes:
an elastic member stretchable along a center line extending in the second direction and configured to bias the shaft member;
a return plunger positioned between the elastic member and the shaft member in the second direction, movable along the center line, and configured to transmit a biasing force of the elastic member to the shaft member; and
a guide member attached to the housing, configured to accommodate the return plunger inside the guide member and to guide movement of the return plunger, and having higher heat resistance than the housing.

2. The limit switch according to claim 1, wherein
the operation unit is configured to rotatably support an end portion of the shaft member positioned inside the housing, and includes a support member 23 having higher heat resistance than the housing.

3. The limit switch according to claim 1, wherein
the operation unit includes:
an operation lever positioned at an end portion of the shaft member positioned outside the housing; and
a fastening member that fixes the operation lever to the shaft member, and
the fastening member includes:
a shaft extending along a third direction intersecting the first direction and the second direction and provided with a recessed portion that houses a part of the shaft member; and
a nut positioned at one end of the shaft.

4. The switch according to claim 1, wherein
the elastic member includes two coil springs having different diameters.

5. The limit switch according to claim 1, wherein
the switch main body includes a switch portion configured to be switched on and off by rotation of the shaft member, and
the switch portion is made of a material containing polyether ether ketone resin.

6.

6. The limit switch according to claim 1, wherein
the operation unit includes fluorine grease applied to the shaft member.

7. The limit switch according to claim 2, wherein
the operation unit includes:
an operation lever positioned at an end portion of the shaft member positioned outside the housing; and
a fastening member that fixes the operation lever to the shaft member, and
the fastening member includes:
a shaft extending along a third direction intersecting the first direction and the second direction and provided with a recessed portion that houses a part of the shaft member; and
a nut positioned at one end of the shaft.

8. The switch according to claim 2, wherein
the elastic member includes two coil springs having different diameters.

9. The limit switch according to claim 2, wherein
the switch main body includes a switch portion configured to be switched on and off by rotation of the shaft member, and
the switch portion is made of a material containing polyether ether ketone resin.

10. The limit switch according to claim 2, wherein
the operation unit includes fluorine grease applied to the shaft member.
